(19) United States
(12) Patent Application Publication
(10) Pub. No.: US 2010/0071220 A1
(43) Pub. Date: Mar. 25, 2010

(54) Laser Centering Tool

(76) Inventors: Charles C. Thompson, Shawnee, OK (US); Pete L. Bonicelli, JR., McAlester, OK (US)

Correspondence Address: MARTIN S. HIGH, P.O. BOX 217, STILLWATER, OK, 74076, US

(21) Appl. No.: 12/563,826

(22) Filed: Sep. 21, 2009

Related U.S. Application Data
(60) Provisional application No. 61/098,785, filed on Sep. 21, 2008.

(51) Int. Cl. G01B 11/00

(52) U.S. Cl. 33/228; 33/286

(57) ABSTRACT

An embodiment of the laser centering tool is comprised of a plurality of integrally formed, flat, concentric cylinders, wherein the concentric cylinders form an aperture that accepts a means to low power laser beam. The aperture is formed along the centerline of the concentric cylinders. The plurality of integrally formed, flat, concentric cylinders are arranged in increasing diameter wherein the largest diameter cylinder is on one side of the laser centering tool and the cylinder with the smallest diameter is on the other side of the laser centering tool. The embodiment is further comprised of a low power laser beam generating means that is inserted in the centerline aperture. The low power laser beam generating means is a low-power, battery operated laser and is held in place in the aperture through a resistance fit, a threaded connection, or a glued connection.

### CROSS-REFERENCE TO RELATED APPLICATIONS

This application claims priority of U.S. Provisional Patent Application Ser. No. 61/098,785 of the same title filed on Sep. 21, 2008. The entire contents of U.S. Provisional Patent Application are herein incorporated by reference.

### STATEMENT REGARDING FEDERALLY SPONSORED RESEARCH OR DEVELOPMENT

Not applicable

### FIELD OF THE EMBODIMENTS

The field of the embodiments is generally the construction industry including the plumbing and electrical construction industry.

BACKGROUND OF THE EMBODIMENTS

Plumbers, electricians and other construction professionals routinely need to determine the extension of a center line of a punch out from an electrical or plumbing connection box onto a wall, ceiling or other surface removed from electrical box. For example, electricians often mount an electrical box and then route electrical conduits to and from the box through an adjacent or surrounding wall or ceiling. The conduits frequently have to pass through walls and ceiling structures at a precise point. However, it is difficult to determine the proper location of the hole in the wall or ceiling to accommodate the conduit once the electrical box is mounted. In most cases, the electrical box must be mounted first and followed by the determination of the location of the cutout in the wall. The embodiments described herein allow for the exact and ready determination of the location of the conduit hole given the location of the mounted electrical box or plumbing fixture.

### SUMMARY OF THE EMBODIMENTS

An embodiment of the laser centering tool is comprised of a plurality of integrally formed, flat, concentric cylinders, wherein the concentric cylinders form an aperture that accepts a means to generate a low power laser beam. The aperture is formed along the centerline of the concentric cylinders. The plurality of integrally formed, flat, concentric cylinders are arranged in increasing diameter wherein the largest diameter cylinder is on one side of the laser centering tool and the cylinder with the smallest diameter is on the other side of the laser centering tool. Stated alternatively, the integrally formed cylinder with the smaller inside diameter (“inner cylinder”) is integrally formed onto one of the faces of the next larger cylinder (“outer cylinder”) such that the two cylinders form a stair-stepped structure. The embodiment is further comprised of a low power laser beam generating means that is inserted in the centerline aperture. The low power laser beam generating means is a low-power, battery operated laser and is held in place in the aperture through a resistance fit, a threaded connection, or a glued connection. The embodiments of the invention can center a hole from an electrical or plumbing box in any orientation, but primarily in the horizontal or vertical configuration.

### BRIEF DESCRIPTION OF THE DRAWINGS

FIG. 1 is a perspective view of the laser centering tool installed in an electrical box showing the inner cylinder and the positioning of the laser means.

FIG. 2 is a top view showing the positioning of the outer cylinder, the inner cylinder and the laser means and the magnetic fasteners.

FIG. 3 is a perspective view of the laser centering device showing the outer cylinder, the inner cylinder, the laser means and the magnetic fasteners.

FIG. 4 is a side view showing the relative positions of the laser means, the inner cylinder and the outer cylinder.

FIG. 5 is a perspective view of the laser centering device showing the laser means, the inner cylinder, the outer cylinder and the magnetic attachment.

FIG. 6 is a top view showing the laser centering device installed in an electrical box showing the inner cylinder and the laser mean.

FIG. 7 is a perspective view of the laser centering device with the laser means activated showing the laser beam.

FIG. 8 is a schematic of the laser of the laser centering device installed in an electrical box showing the laser activated and illuminated on a ceiling showing the position of the center of the electrical box.

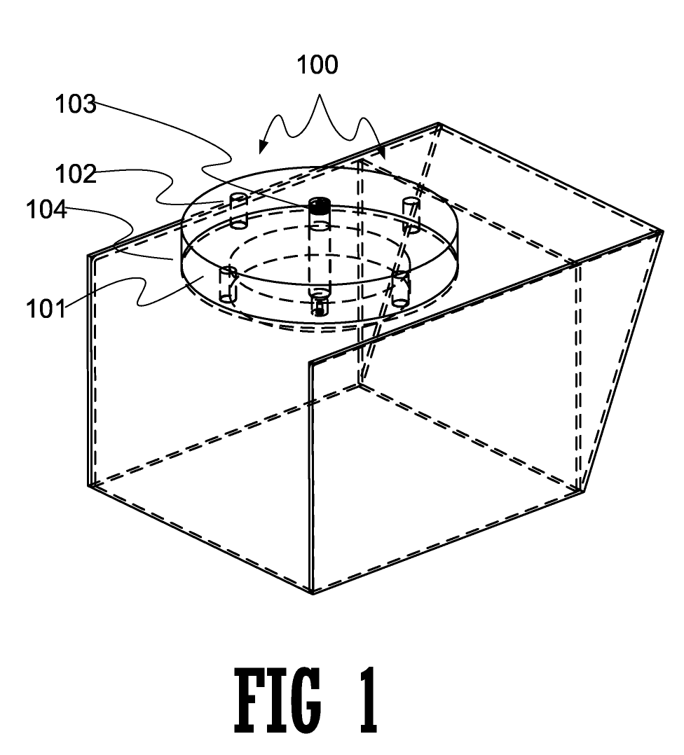

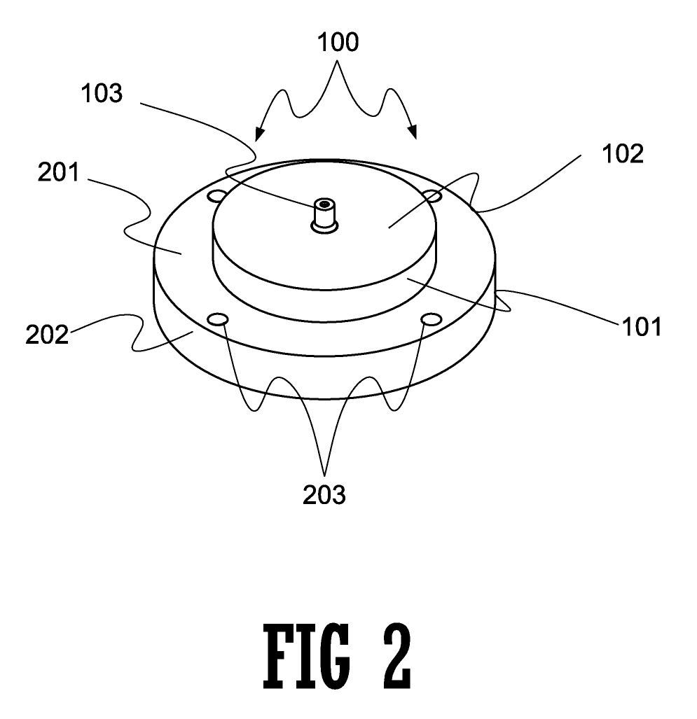

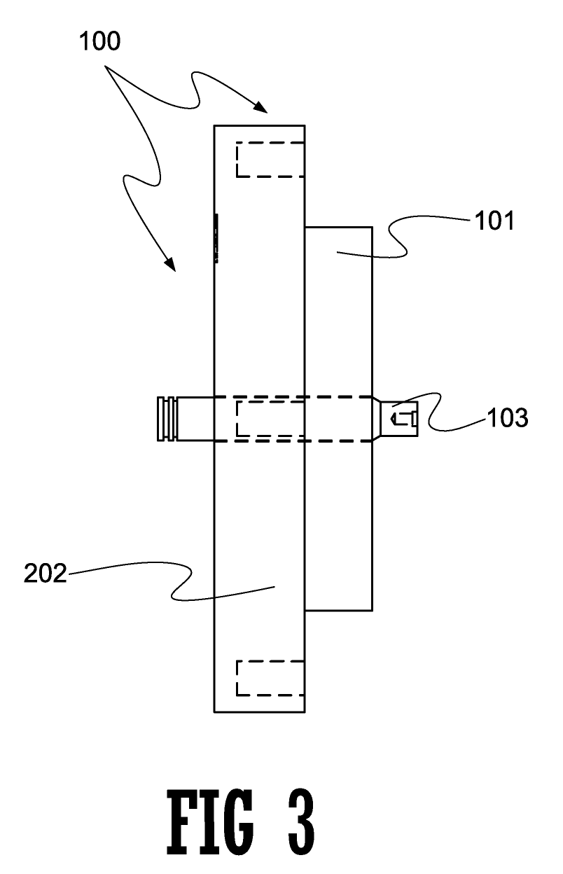

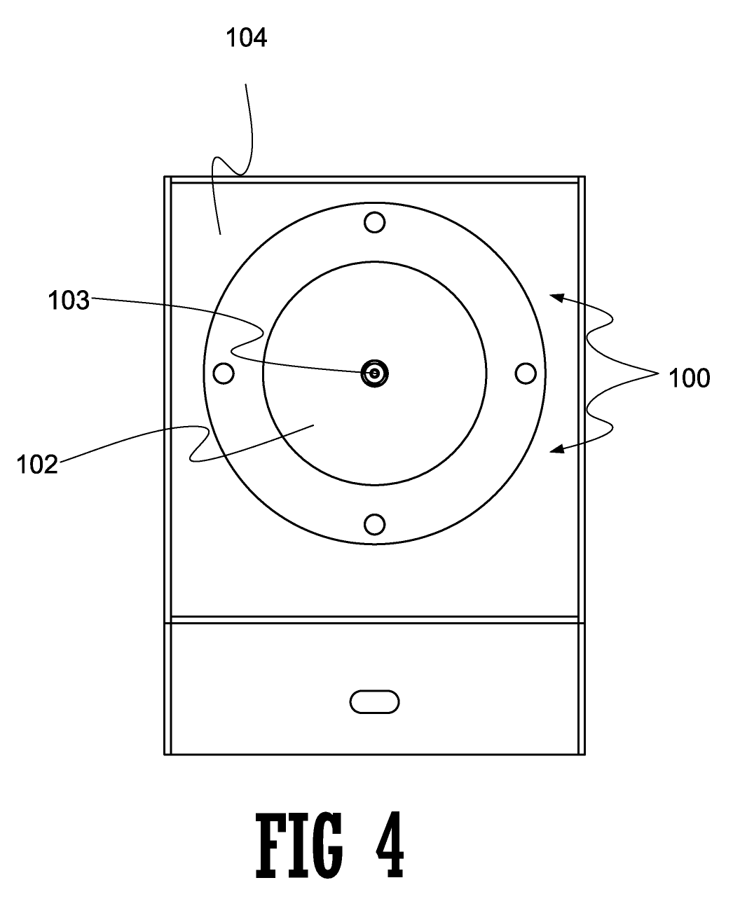

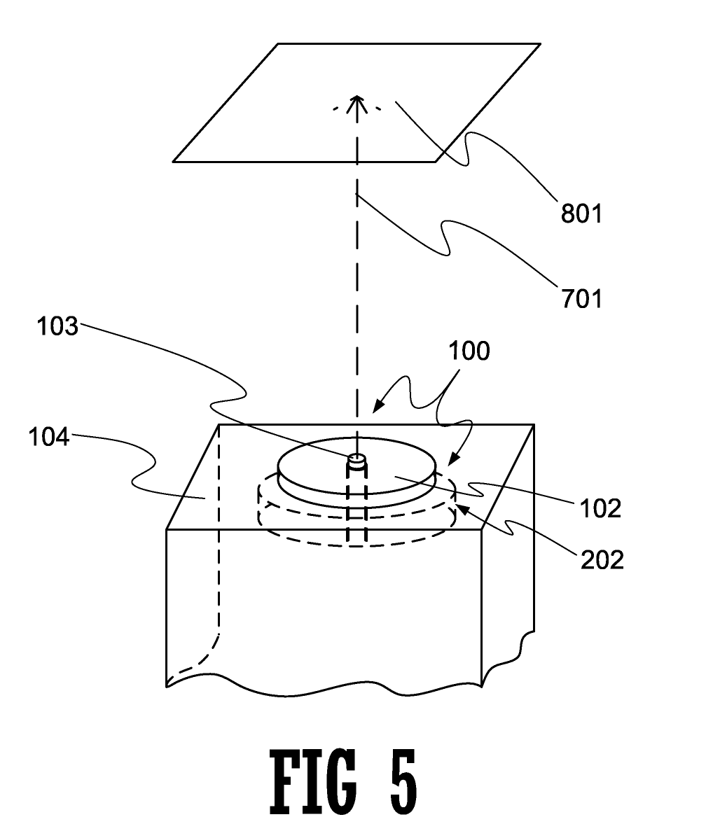

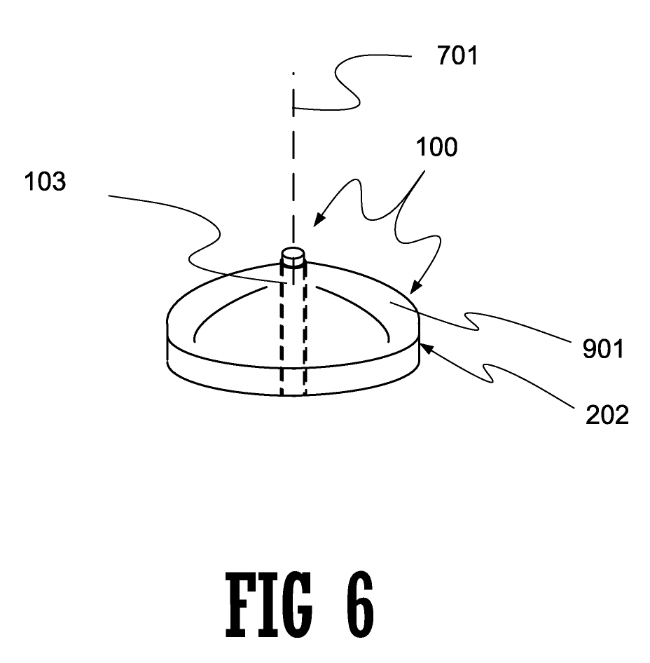

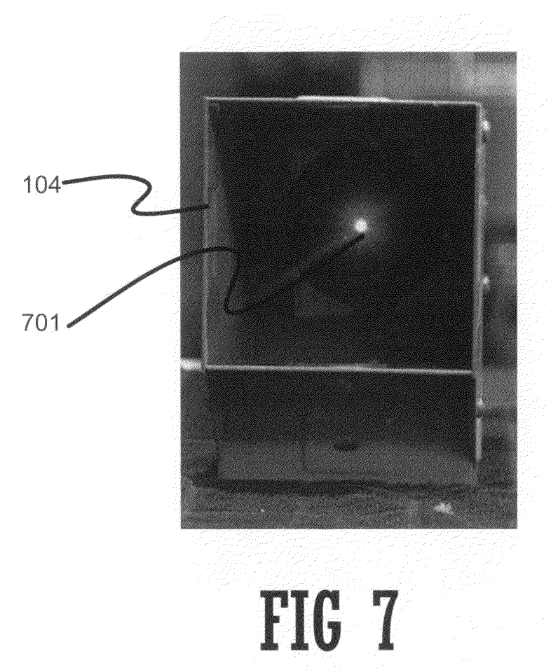

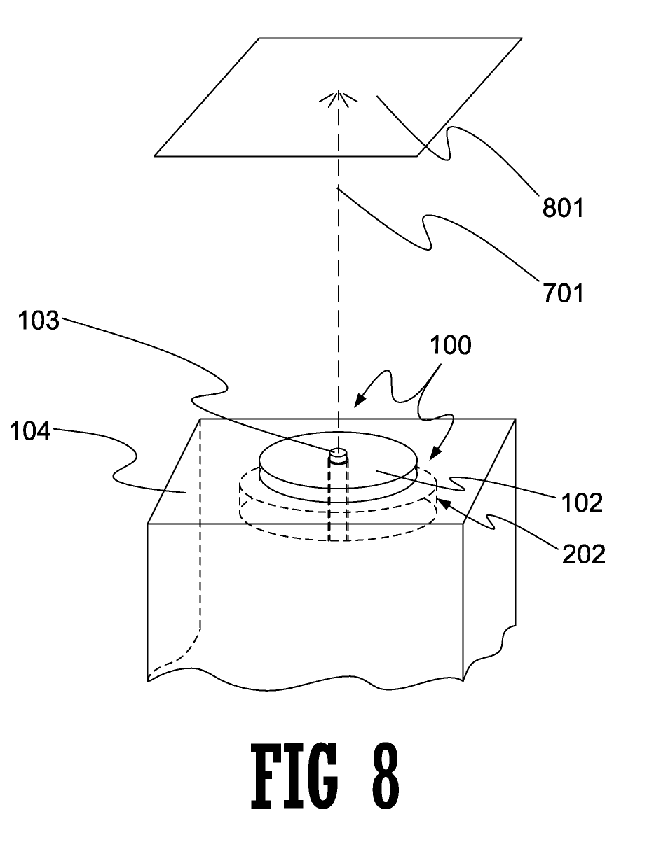

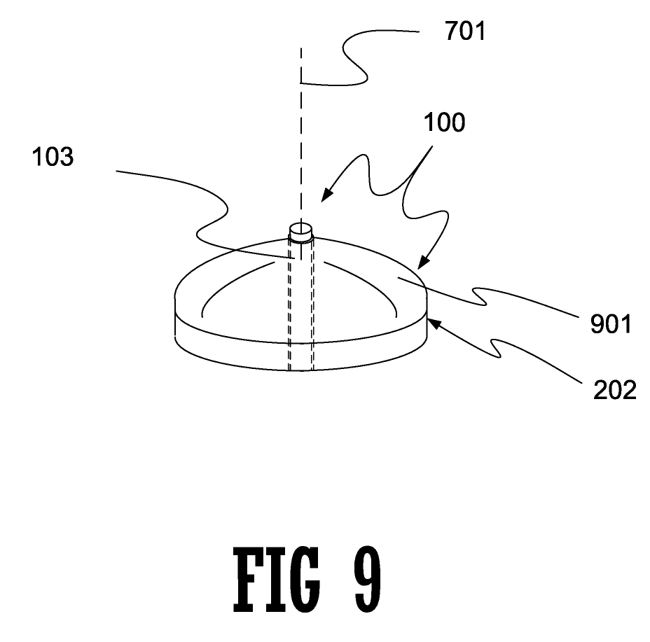

### DETAILED DESCRIPTION OF THE PREFERRED EMBODIMENTS

An embodiment of the laser centering tool 100 is comprised of a plurality of integrally formed, flat, concentric cylinders, wherein the concentric cylinders form an aperture that accepts a means to low power laser beam. The aperture is formed along the centerline of the concentric cylinders. The plurality of integrally formed, flat, concentric cylinders are arranged in increasing diameter wherein the largest diameter cylinder is on one side of the laser centering tool 100 and the cylinder with the smallest diameter is on the other side of the laser centering tool 100. The cylinder with the smallest diameter extends through the electrical or plumbing box such that the sides of the cylinder extend through the box. Stated alternatively, the integrally formed cylinder with the smaller inside diameter is integrally formed onto one of the faces of the next larger cylinder such that the two cylinders form a stair-stepped structure. The embodiment is further comprised of a low power laser beam generating means that is inserted in the centerline aperture.

The laser generating means is a low-power, battery operated laser and is held in place in the aperture through a resistance fit, a threaded connection, or a glued connection.

In another embodiment of the laser centering tool 100 the plurality of integrally formed, flat, concentric cylinders is comprised of two integrally formed, flat, concentric cylinders. One of the concentric cylinders in this embodiment is a large diameter cylinder 201 and the other cylinder is a small diameter cylinder 102. The small diameter cylinder 102 extends through the electrical box such that the sides of the larger cylinder 202 extend below the electrical box 104 so that the user can grasp the laser centering tool 100 and insert and remove the tool. The smaller diameter cylinder with the smallest diameter extends through the electrical or plumbing box such that the sides of the small cylinder 101 extend through the electrical box 104.

An aperture is formed along the centerline of the concentric cylinders. The embodiment of the laser centering tool 100 is further comprised of a low power laser beam generating means 103 that is inserted in the centerline aperture. The low power laser beam generating means 103 is a low-power, battery operated laser and is secured by a resistance fit, a threaded fit, or via a chemical or glue bonding means. In one embodiment the low power laser beam generating means 103 has a touch switch.

Each concentric cylinder has pressed into its outer circumference one or more magnets 203. These magnets serve as a means to secure the laser centering tool 100 to the electrical or plumbing box 104 when inserted by the user. The magnets hold the laser centering tool 100 in place while the user marks the center spot designated by the laser beam. The magnets can be long extended magnets that extend essentially completely around the circumference of each concentric cylinder. In another embodiment, the magnets are a plurality of small round magnets 203 pressed into apertures formed by the material of the concentric cylinders.

A best mode of operation of the laser centering device is to place the laser centering device into a precut aperture in an electrical or plumbing box 104 such that the smallest concentric cylinder is permitted to pass through the pre-cutout opening in the box 104 and inserted through the pre-cutout opening. At that point, the laser centering device is held in place by hand or held in place by the action of the magnets on the metallic material of the electrical or plumbing box 104 and the laser means is activated. Given that the electrical or plumbing box 104 is properly plumbed relative to the house, the laser that emanates from the laser device is illuminated across an area which then is used to mark the centerline of the electrical box 104. In this way the laser centering device can be used to mark the center of an opening across open space.

In another best mode of operation of the best mode of operation of the laser centering device is to place the laser centering tool into a punched out cutout in an electrical or plumbing box, centering the laser centering tool in the punched out cutout in an electrical or plumbing box, activating or powering on the laser generating means, then locating the point where the laser beam intersects the opposing wall, ceiling, or surface, and marking the point the laser beam intersects the opposing wall, ceiling, or surface.

In some applications the electrical or plumbing box 104 is too small to permit the insertion of laser centering device with a plurality of cylinders. Another embodiment of the laser centering device would be comprised of the outer cylinder to be offset only slightly from the small cylinder to fit in this application.

In another embodiment, the larger cylinder would be a cam, egg half moon shaped 901 to fit smaller applications. This embodiment of the laser centering tool comprises a cylinder upon which is formed an integral cam, egg, or half moon shape to operate in applications involving tight spaces, a laser generating means, and one or more magnets.

An example, the laser centering device could be installed into an electrical box 104 in a vertical orientation so that the laser beam 701 emanating from the laser centering device illuminates a dot on the ceiling 801 of the area in which an electrical device is installed. That dot would represent the centerline in the electrical box 104. Therefore, the user of the laser centering device would know the centerline along any line that the laser emanating from the laser device laser means can emanate and cross the open space. Another operation of the laser centering device, the laser centering device could be oriented in a horizontal fashion and allow the laser to illuminate a centerline along a horizontal direction. Therefore, the laser centering device can be used in both horizontal or vertical application. In fact, the laser centering device can be using in any orientation.

1. A laser centering tool comprising
a laser generating means,
a plurality of integrally formed, concentric cylinders wherein the concentric cylinders form an imaginary centerline, and wherein the concentric cylinders form a stair-stepped structure wherein along centerline of the concentric cylinders the cylinders form an aperture that accepts the laser generating means, and
one or more magnets.

2. A laser centering tool as described in claim 1 wherein
the laser generating means is secured by a resistance fit, a threaded fit, or via a bonding means,
the laser generating means generates a laser beam along the centerline of the concentric cylinders extending away from the centering tool from the side of the centering tool on which the stair-stepped structure is formed.

3. A laser centering tool as described in claim 2 wherein one or more magnets are pressed into the surface of the cylinder with large inside diameter so that the magnets form a magnetic bond with an electrical or plumbing box thereby holding the laser centering tool in place while a laser generating means generates a laser beam extending along the imaginary centerline.

4. A laser centering tool described in claim 3 wherein the plurality of integrally formed, concentric cylinders is comprised of two integrally formed, concentric cylinders wherein one of the two, integrally formed, concentric cylinders has a larger outside diameter and one has a smaller inside diameter

5. The laser centering tool described in claim 4 wherein the one or more magnets are comprised of three, four, five or six magnets.

6. The laser centering tool described in claim 3 wherein the large cylinder is offset only slightly from the small cylinder to operate in applications involving tight spaces.

7. A laser centering tool comprising
a laser generating means,
a cylinder upon which is formed an integral cam, egg, or half moon shape to operate in applications involving tight spaces wherein the cam, egg, or half moon shape form an imaginary centerline wherein at the imaginary centerline of the cam, egg, or half moon shape the cam, egg, or half moon shape form an aperture that accepts the laser generating means, and
one or more magnets.

8. A laser centering tool as described in claim 7 wherein
the laser generating means is secured by a resistance fit, a threaded fit, or via a bonding means,
the laser generating means generates a laser beam along the imaginary centerline of the integral cam, egg, or half moon shape extending away from the centering tool from the side of the centering tool on which the integral cam, egg half, or moon shape is formed.

9. A laser centering tool as described in claim 8 wherein one or more magnets are pressed into the integral cam, egg, or half moon shape so that the magnets form a magnetic bond with a electrical or plumbing box thereby holding the laser centering tool in place while a laser generating means generates a laser beam extending along the imaginary centerline.

10. The laser centering tool described in claim 9 wherein the one or more magnets are comprised of four magnets.

11. The method of using laser centering tool comprising the steps
placing the laser centering tool into a punched out cutout in an electrical or plumbing box,
centering the laser centering tool in the punched out cutout in an electrical or plumbing box,
activating or powering on the laser generating means,
locating the point where the laser beam intersects the opposing wall, ceiling, or surface, and
marking the point the laser beam intersects the opposing wall, ceiling, or surface.

12-20. (canceled)
